(19) United States
(12) Patent Application Publication
(10) Pub. No.: US 2002/0136807 A1
(43) Pub. Date: Sep. 26, 2002

(54) Accommodation bag

(76) Inventor: Shigeo Ozawa, Minato-ku (JP)

Correspondence Address: Lowe Hauptman Gopstein Gilman & Berner LLP, 1700 Diagonal Road, Suite 310, Alexandria, VA, 22314, US

(21) Appl. No.: 09/519,999

(22) Filed: Mar. 6, 2000

(30) Foreign Application Priority Data
Nov. 2, 1999 (JP) 11-313128

(51) Int. Cl. A23B 4/00; A21D 10/02

(52) U.S. Cl. 426/128

(57) ABSTRACT

This invention consists of an accommodation bag such that one outer bag accommodates multiple inner accommodation bags and at least one of the inner accommodation bags is a liquid-accommodation bag from which a liquid flows. Also, the liquids or goods that flow out from other multiple accommodation bags in the outer bag are processed and used by mixing with or coming into contact with each other. Therefore, it is also possible to use the processed liquid for drinking or eating by taking it via the bottom of the outer bag. As a heating means, either an outside means, such as a microwave oven or the like, or an independent container installed inside the liquid-accommodation bag, is used. The heat-generation means inside the liquid-accommodation bag is such that heat is generated when there are combined together at least two kinds of materials that generate heat by chemically reacting together, and such that only such generated heat can be utilized.

### BACKGROUND OF THE INVENTION

1. FIELD OF THE INVENTION

This invention relates to an accommodation bag wherein mixing of plural number of liquids to be processed (heating or mixing), or of the aforementioned liquids and goods is made possible in one external package by heating with the usage of an outer pressure or a microwave oven and the like, and an accommodation bag equipped with a heat generation means for generating a heat generation chemical reaction in an independent bag in the liquid accommodation bag without being mixed with the liquids, and making it possible for using only the heat thus generated.

2. DESCRIPTION OF THE PRIOR ART

Conventionally, when a liquid or the plural number of goods are planned to be used by heating or mixing, it required a labour and a time for preperation of a heating apparatus as they are stored in separate containers and the like respectively. There has been no apparatus having such a structure as to carry out these operations in one outer package easily. As to the foods, for saving a cooking time and a labour, the frozen foods or processed foods, which are cooked foods being frozen in a pack, are used as easily preparable ones for edible condition. As to such a beverage as tea or coffee, it requires water and heating, and generally takes a time/labour for preparation. Nothing is existed so far for which becomes drinkable by applying the heat only.

### SUMMARY OF THE INVENTION

1. Problems to be Resolved by the Invention

When the plural kinds of liquids of different quality are mixed or mixed with other goods, there has been a problem that the quality is rapidly deteriorated. In the case of the foods, the taste is lost and a validity period is shortened as well. The frozen foods have a problem that it takes time and labour for thawing and the taste becomes deteriorated. As to the processed foods, since it is preseasoned, the taste is lowered if it elapses a long time. There are some which become edible just by heating with a microwave oven, but a variety is limited and seasoning is also limited to a simple one.

2. Means of Solving the Problem

For making it possible to easily carry out heating or mixing of plural goods in one bag, this invention has a basic structure wherein the plural number of accommodation bags are installed in one outer bag in a manner that at least one of which is a liquid accommodation bag, having a heating means in it when necessary. Namely, it is constituted with a heat resistance outer bag having a vapor releasing hole on a top face, which is to be formed in accordance with an inside pressure of the accommodation bag, and a heat resistance liquid accommodation bag being installed in the outer bag accommodating the foods accommodation bag and the liquid. When the accommodation bag is heated by a microwave oven and the like, the liquid in the liquid accommodation bag flows out by a pressure inside the bag so as to make it possible for immersing and heating the foods in the foods accommodation bag, which allows a passage of the liquid. Also, in a case that the number of liquid accommodation bag is plural, the mixture of the plural liquids is carried out in one outer bag.

The accommodation bag is also constituted with a heat resistance outer bag having a vapor releasing hole on the upper face and a hot water releasing hole formed on the bottom face, a heat resistance liquid/foods accommodation bag which accommodates the liquid/foods and allows the passage of the hot water is installed in the outer bag, and a heat resistance liquid accommodation bag which accommodates the liquid and is installed in the outer bag piled over the liquid/foods accommodation bag, wherein the liquid in the liquid accommodation bag is made to boil and the boiled water flows out over the liquid/foods accommodation bag when the outer bag is heated by the microwave oven and the like. Also, the vapor releasing hole, the hot water releasing hole and a means provided with the liquid accommodation bag for making the liquid flow out possible are holes to be formed respectively by heating, and are covered by sealings before being heated. Stripping off timing of the seals are different depending on the holes respectively. Therefore, vapor flow up time can be set arbitrarily, depending on the difference of heating conditions, strength or material of the seal. An expansion free displaying means is mounted so as to make a vapor pressure variation inside the accommodation bag visible.

Further, as to a method for heating the outer bag, the problem is solved by installing a heating means in the liquid accommodation bag. Namely, the heating means is independently installed in the liquid accommodation bag and has a means to obtain a heat generation by mixing, when they are used, at least two kinds of materials for generating the heat by chemical reaction.

### BRIEF DESCRIPTION OF THE DRAWINGS

FIG. 1 is a brief cross-sectional view of the accommodation bag,

FIG. 2 is an operation explanation drawing of the accommodation bag, and

FIG. 3 is an explanatory drawing of the display bag expandedly formed accompanied by rising of an internal vapor pressure.

### DETAILED DESCRIPTION OF THE INVENTION

1. Embodiments of the Invention.

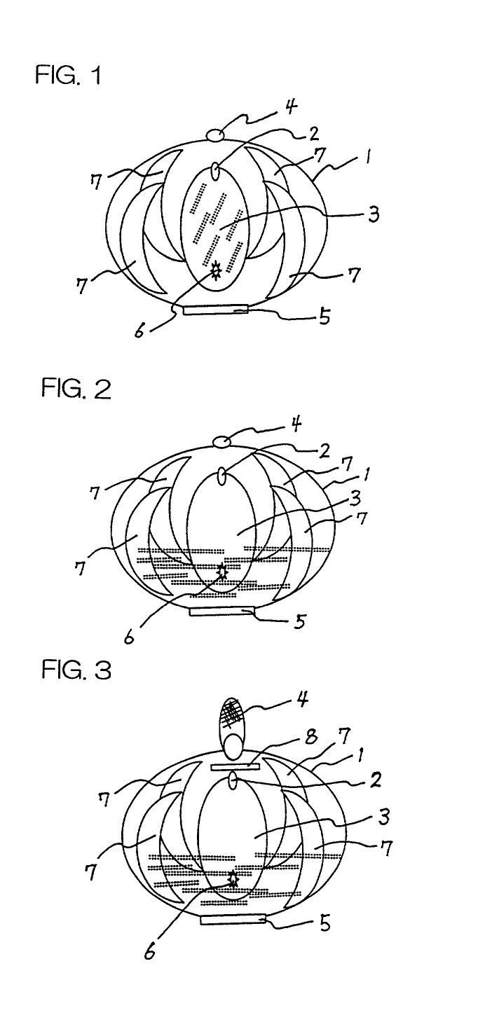

As shown in FIG. 1, the accommodation bag comprises the outer bag 1, the liquid accommodation bag 3, the accommodation bag 7 which accommodates eating/drinking goods and the like, and the heating means 6. Each of the bag is made by adhering the two piled up sheets of synthetic resin material being superior in a heat resistance and by applying a heat sealing to its periphery. On the top face of the outer bag 1, a vapor pressure releasing hole 4 is formed, and on the bottom face of the bag 1, a hot water releasing hole 5 is formed and they are covered by seals. Since an inner part of the outer bag 1 becomes a high pressure, the reinforcement seals are pasted to an outside of the top face, and an inside of the bottom face so that the holes are not torn out. A vapor pressure discharge adjusting packing seal is pasted to an inside of the upper face. The vapor pressure discharge adjusting packing seal is formed with a foaming polyester, flocked polyurethane foam and the like, which are durable for water and superior in gas permeability and elasticity having a width of 2 mm to 5 mm degree.

The liquid accommodation bag 3 is also made of two similar synthetic resin material sheets by being piled over similarly to that of the outer bag 1, whose periphery is heat sealed and formed in a bag shape, in which a fluid is accommodated. The liquid in the liquid accommodation bag 3 outflows from the bag 3 when it is heated, but an outflow temperature of the liquid can be adjusted by a position of the hole. In the figure, the liquid flow-out hole position is formed on the top so as to flow out as a vapor, the hole may be formed at the bottom. In this case, a vapor pressure inside the liquid accommodation bag 3 should be closed so that it is opened at a higher vapor pressure than the one when the hole is formed at the top. The fig.2 is describes a status where the liquid is flowed out from the bag 3, and the fig.3 describes a status where the vapor releasing hole 4 is formed on the expansion free member, which becoming visible by expansion of the vapor pressure inside the accommodation bag. Both of figures are describing where the heating means 6 is installed in the bag 3 but, when heating is carried out by the microwave oven, the heating means 6 is not required to be installed in an accommodation bag 7. A heating time display 8 in the fig.3 is displaying a vapor blow up time. It can be useful for preventing a danger.

In the eating/drinking goods accommodation bag 7, a favorite beverage such as a black tea, Japanese tea, oolong tea and the like may be accommodated. The bag is made by overlaying two sheets of capillitium net or a non-woven cloth formed with a synthetic resin material. The sheet is superior in heat resistance and cold resistance property. The periphery of the sheet is also adhered in degree of 5 mm or 10 mm width. The bag 7 is also acting as a filtering bag. When the ground coffee beans are accommodated, the bag is used as an eating/drinking goods accommodation bag 7 in a condition that the ground beans are clamped with a filtering paper from the above and the bottom. At the bottom of the eating/drinking goods accommodation bag 7, one or several or crossing synthetic resin material fiber thread of 0.5 mm degree or a net is provided so as to rapidly and smoothly passes hot water of the black tea or coffee, and carry out a pressure adjusting function smoothly in the eating/drinking goods accommodation bag 7. The eating/drinking goods accommodation bag 7 is pasted to a bottom inner side of the outer bag 1 with heat sealing.

With reference to the heating device 6 installed inside the liquid, it is considered to be a double constitution for utilizing a chemical reaction, wherein an oleaginous oil is used on one part and a compound and the like composed of calcium and carbon is used on the other so that it yields a high temperature by reacting them when they are used.

2. Effects of the Invention

The accommodation bag of this invention enables, as described above, to provide a cooking method of entirely new, simple and capable of processing or seasoning with the usage of a heat generation apparatus such as a microwave oven. Also, the bag is so deliberated that the favorite beverage such as a coffee, tea and the like is made ready for a drinkable condition without newly preparing a water. Further, the bag enables to supply a plural of materials, without deteriorating the tastes, keeping their quality stable, since the mixture or processing can be carried out when they are used.

Likewise, since it provides a simple processing method wherein even a heat generation device such as the electronic oven is not required due to an internal heat generating apparatus, this invention can greatly contribute to the industry as the relief goods at the time of an emergency such as an occurrence of the earthquake and the like or an accident, or for areas where a relief is asked for.

Explanation of Code

1 Outer bag

2 Liquid releasing hole

3 Liquid accommodation bag

4 Vapor releasing hole

5 Boiled water releasing hole

6 Heating means

7 Accommodation bag

8 Heat time display

What is claimed is:

1. An accommodation bag wherein it comprises, an outer bag and one or more accommodation bags which have independent spaces from the outer bag and are yet accommodated in the outer bag.

2. An accommodation bag described in claim 1, wherein at least one of the accommodation bags is made capable of outflowing an inside liquid by heating.

3. An accommodation bag described in claim 1 or 2, wherein the outer bag is equipped with a vapor releasing hole.

4. An accommodation bag described in either of claim 1 to claim 3, wherein a boiled water releasing hole is equipped on the bottom face of the outer bag.

5. An accommodation bag described in either of claim 1 to claim 4, wherein the accommodation bags are capable of passing the boiled water through.

6. An accommodation bag described in either of claims to 1 to 5, wherein at least one of the bags accommodates a liquid and a heating means for heating the liquid thereof.

7. An accommodation bag described in either of claim 1 to claim 6, wherein the vapor releasing hole is sealed by a member being equipped with a vapor blow out time adjusting function.

8. An accommodation bag described in claims 1 to 7, wherein the vapor releasing hole is formed integrally with an expansion free display means for displaying an inside pressure of the outer bag, depending on the degree of expansion.

9. An accommodation bag described in claim 1 to claim 8 wherein the heating means is installed in a sealed container being sheltered from the inside of the accommodation bag in a manner that at least two kinds of materials, which generate a heat by chemical reaction, are separately stored so as to be mixed by an outer pressure.
